(19) United States
(12) Patent Application Publication
(10) Pub. No.: US 2008/0220176 A1
(43) Pub. Date: Sep. 11, 2008

(54) PICKERING EMULSIONS, AQUEOUS DISPERSIONS OF POLYMERIC PARTICLES, COATINGS, AND PARTICLE NETWORKS FORMED THEREFROM

(75) Inventors: Leland H. Carlblom, Gibsonia, PA (US); Terri L. Ziegler, Cranberry Township, PA (US); Mary Ann M. Fuhry, Butler, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/679,332

(22) Filed: Feb. 27, 2007

(51) Int. Cl. C08J 3/02

(52) U.S. Cl. 427/445; 523/200; 523/334; 524/457; 524/458

(57) ABSTRACT

Disclosed are Pickering emulsions, related aqueous dispersions, and methods for their preparation, both of which include the use of a water insoluble promoter. Also disclosed are coatings and particle networks formed therefrom.

### FIELD OF THE INVENTION

The present invention relates to Pickering emulsions that include a water insoluble promoter. The present invention also relates to aqueous dispersions of polymeric particles and methods for their preparation, as well as coatings and particle networks formed from such dispersions.

### BACKGROUND INFORMATION

Aqueous dispersions of polymeric particles are sometimes formed by polymerization of monomers included in an emulsion that includes a monomeric dispersed phase and an aqueous continuous phase. Emulsions are systems that include two liquids which are immiscible or have only limited miscibility with one another. In an emulsion, one of the two liquids is the dispersed phase, i.e., it is dispersed in the form of fine droplets in the other liquid, which is often referred to as the continuous phase.

To achieve permanent dispersion of the dispersed phase in the continuous phase, emulsions traditionally require the addition of a surface-active substance, i.e., a surfactant. These substances typically have an amphiphilic molecular structure, which includes a polar hydrophilic molecular moiety and a nonpolar lipophilic molecular moiety. Surfactants can act to lower the interfacial tension between the dispersed phase and the continuous phase by positioning themselves at the interface therebetween, and forming an interfacial film that prevents irreversible coalescence of the dispersed droplets. Such an approach is often acceptable for producing emulsions, such as emulsions used in the formation of coatings, however, in the case of coatings, the presence of the surfactant in the cured coating tends, in at least some cases, to negatively impact the resultant coating film properties, such as the water resistance of the coating. This may be unacceptable in certain applications.

A particular type of emulsion, sometimes known as a Pickering emulsion, utilizes solid particles as a stabilizer, i.e., as a material that stabilizes the droplets of the dispersed phase in the continuous phase. An advantage of these emulsions is that they typically utilize little or no surfactant. In a Pickering emulsion, the solid particles are arranged at the interface between the two liquid phases, where they form a mechanical barrier against the combining of the liquid droplets of the dispersed phase. FIG. 1 is a schematic depiction of what occurs in a Pickering emulsion in which solid particles are used as a stabilizer. As is apparent from this Figure, a dispersed phase 10 is disposed in the form of a droplet within a continuous phase 20 and the dispersed phase 10 is coated with a substantially continuous layer of stabilizing particles 30.

Solid particles that are sometimes used as a stabilizer in Pickering emulsions include hydrophilic, essentially organophobic, materials, such as clay particles, colloidal silica, inorganic particles, such as metal oxides and nitrides, and lightly crosslinked latex particles. To function as a stabilizer, however, such particles must be wetted by both phases of the emulsion. In other words, they must be rendered at least partially organophilic. As a result, a second component, often called a promoter, is often required to achieve a stable Pickering emulsion. The promoter is believed to function by adsorbing to the surface of the solid particles, thus driving the particles to the interface of the dispersed phase and the continuous phase.

Historically, water-soluble materials have been used as promoters in oil-in-water Pickering emulsions that utilize, for example, silica particles as the stabilizer. Water soluble materials have had the perceived advantage of having an affinity for the hydrophilic surface of the stabilizing particles. Thus, it is believed, such materials are easily drawn to the surface of the stabilizing particles. A disadvantage to such promoters, however, is that they can cause stability problems as a result of flocculation or bridging of polymer particles enclosed by the layer of stabilizer particles. This disadvantage is particularly problematic when it is desired to produce an aqueous dispersion of polymeric particles from such an emulsion that is to be used in the formation of a protective and decorative coating. Moreover, while this flocculation effect can be counteracted through the use of pH buffers, these materials can have adverse effects on coating properties, such as humidity resistance and/or yellowing.

As a result, it would be desirable to provide Pickering emulsions that utilize a promoter that overcomes at least some of the previously described disadvantages of the prior art.

### SUMMARY OF THE INVENTION

In certain respects, the present invention is directed to oil-in-water Pickering emulsions. These emulsions comprise: (a) a dispersed phase comprising droplets of a polymerizable monomer coated with a substantially continuous layer of stabilizing solid particles having a water insoluble promoter adsorbed thereto; and (b) a continuous phase comprising an aqueous medium. In these emulsions, the substantially continuous layer of stabilizing solid particles is disposed at the interface between the dispersed phase and the continuous phase.

In other respects, the present invention is directed to aqueous dispersions comprising polymeric particles coated with a substantially continuous layer of stabilizing solid particles having a water insoluble promoter adsorbed thereto, wherein the polymeric particles are dispersed in an aqueous medium.

The present invention is also directed to multiphase coatings comprising: (a) a first phase comprising a plurality of film-forming polymer domains; and (b) a second phase comprising a network of solid particles. In these coatings of the present invention, the plurality of film-forming polymer domains are separated from each other by the network of solid particles.

In still other respects, the present invention is directed to methods for making a network of solid particles. These methods comprise (1) making a Pickering emulsion comprising: (a) a dispersed phase comprising droplets of a polymerizable monomer coated with a substantially continuous layer of stabilizing solid particles having a water insoluble promoter adsorbed thereto; and (b) a continuous phase comprising an aqueous medium, wherein the substantially continuous layer of stabilizing solid particles is disposed at the interface between the dispersed phase and the continuous phase; (2) polymerizing the polymerizable monomer to form an aqueous dispersion comprising polymeric particles coated with a substantially continuous layer of stabilizing solid particles having a water insoluble promoter adsorbed thereto, wherein the polymeric particles are dispersed in an aqueous medium; (3) depositing the aqueous dispersion on a substrate; (4) drying the aqueous dispersion to form a multiphase coating comprising: (a) a first phase comprising a plurality of film-forming polymer domains; and (b) a second phase comprising a network of solid particles, wherein the plurality of film-forming polymer domains are separated from each other by the network of solid particles; and (5) removing the polymeric domains.

### BRIEF DESCRIPTION OF THE DRAWINGS

FIG. 1 is a schematic depiction of a Pickering emulsion;

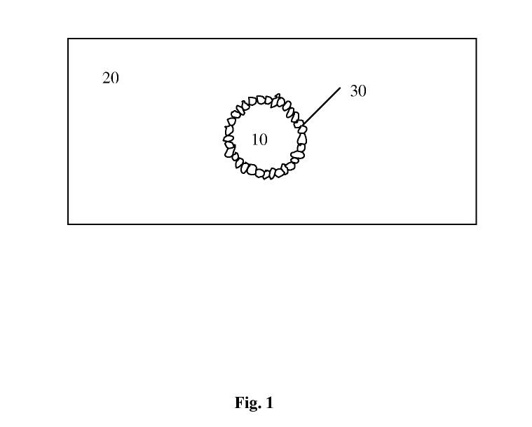

FIG. 2 is a transmission electron microscopy (“TEM”) image (5,000× magnification) of a cross-section of the dried film produced in Example 7;

FIG. 3 is a TEM image (5,000× magnification) of a cross-section of the dried film produced in Example 8; and

FIG. 4 is a TEM image (28,000× magnification) of a cross-section of the dried film produced in Example 9.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously indicated, certain embodiments of the present invention are directed to aqueous dispersions comprising polymeric particles coated with a substantially continuous layer of stabilizing solid particles having a water insoluble promoter adsorbed thereto, wherein the polymeric particles are dispersed in an aqueous medium. In certain embodiments, such aqueous dispersions are formed from an oil-in-water Pickering emulsion. As used herein, the term “oil-in-water Pickering emulsion” refers to an emulsion that utilizes solid particles as a stabilizer to stabilize droplets of an organic substance, such as the polymerizable monomers described below, in a dispersed phase in the form of droplets dispersed throughout a continuous phase, which comprises an aqueous medium. As used herein, the term “adsorbed” refers to the adherence of atoms, ions, or molecules of a gas or liquid to the surface of another substance by a relatively small force, such as a force on the order of van der Waals forces, as opposed to a chemical reaction or covalent bond.

In certain embodiments, the Pickering emulsions of the present invention are substantially free or, in some cases, completely free of any surfactant. As used herein, the term “surfactant” refers to materials that have an amphiphilic molecular structure, which includes a polar hydrophilic molecular moiety and a nonpolar lipophilic molecular moiety, and which acts to lower the interfacial tension between the dispersed phase and the continuous phase in an emulsion. As will be appreciated, surfactants can be classified as ionic (anionic, cationic, and amphoteric) or nonionic. As used herein, the term “substantially free” when used with reference to the absence of surfactant in the Pickering emulsions of the present invention, means that the emulsion comprises less than 0.05 percent by weight of surfactant, based on the total weight of the solid particle stabilizer and polymerizable monomer. As used herein, the term “completely free” when used with reference to the absence of surfactant in the Pickering emulsions of the present invention, means that the emulsion comprises no surfactant at all.

As previously indicated, the oil-in-water Pickering emulsions of the present invention comprise a dispersed phase comprising a polymerizable monomer, such as, for example, a polymerizable, ethylenically unsaturated monomer. Suitable polymerizable ethylenically, unsaturated monomers, include any of the vinyl monomers known in the art. Non-limiting examples of useful ethylenically unsaturated carboxylic acid functional group-containing monomers include (meth)acrylic acid, beta-carboxyethyl acrylate, acryloxypropionic acid, crotonic acid, fumaric acid, monoalkyl esters of fumaric acid, maleic acid, monoalkyl esters of maleic acid, itaconic acid, monoalkyl esters of itaconic acid and mixtures thereof. As used herein, “(meth)acrylic” and terms derived therefrom are intended to include both acrylic and methacrylic.

Non-limiting examples of other useful ethylenically unsaturated monomers free of carboxylic acid functional groups include alkyl esters of (meth)acrylic acids, for example, ethyl (meth)acrylate, methyl (meth)acrylate, butyl (meth)acrylate, 2-ethylhexyl (meth)acrylate, 2-hydroxyethyl (meth)acrylate, hydroxypropyl (meth)acrylate, hydroxy butyl (meth)acrylate, isobornyl (meth)acrylate, and lauryl (meth)acrylate; vinyl aromatics, such as styrene and vinyl toluene; (meth)acrylamides, such as N-butoxymethyl acrylamide; acrylonitriles; dialkyl esters of maleic and fumaric acids; vinyl and vinylidene halides; vinyl acetate; vinyl ethers; allyl ethers; allyl alcohols; derivatives thereof and mixtures thereof.

The ethylenically unsaturated monomers also can include ethylenically unsaturated, beta-hydroxy ester functional monomers, such as those derived from the reaction of an ethylenically unsaturated acid functional monomer, such as a monocarboxylic acid, for example, acrylic acid, and an epoxy compound which does not participate in the free radical initiated polymerization with the unsaturated acid monomer. Examples of such epoxy compounds are glycidyl ethers and esters. Suitable glycidyl ethers include glycidyl ethers of alcohols and phenols such as butyl glycidyl ether, octyl glycidyl ether, phenyl glycidyl ether and the like. Suitable epoxy compounds include those having the following structure (I):

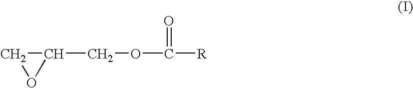

where R is a hydrocarbon radical containing from 4 to 26 carbon atoms. Suitable glycidyl esters include those which are commercially available from Shell Chemical Company under the tradename CARDURA E and from Exxon Chemical Company under the tradename GLYDEXX-10. Alternatively, the beta-hydroxy ester functional monomers can be prepared from an ethylenically unsaturated, epoxy functional monomer, for example glycidyl (meth)acrylate and allyl glycidyl ether, and a saturated carboxylic acid, such as a saturated monocarboxylic acid, for example isostearic acid.

In certain embodiments, the Pickering emulsions described herein are substantially free or, in some cases, completely free, of any amine-containing polymerizable monomer. As used herein, the term the term “substantially free” when used with reference to the absence of amine-containing polymerizable monomer in the Pickering emulsions of the present invention, means that the emulsion comprises no more than 0.5 percent by weight of amine-containing polymerizable monomer, based on the total weight of the polymerizable monomer(s) present in the emulsion. As used herein, the term “completely free” when used with reference to the absence of amine-containing polymerizable monomer in the Pickering emulsions of the present invention, means that the emulsion comprises no amine-containing polymerizable monomer at all. As used herein, the term “amine-containing polymerizable monomer” refers to polymerizable monomers containing one or more amine groups.

In certain embodiments, the Pickering emulsions of the present invention comprise a dispersed phase comprising, in addition to the previously described polymerizable monomer, a water insoluble polymer. In these embodiments, such a water insoluble polymer is distinct from and does not function as a promoter, unlike the water insoluble promoters described hereinafter.

In certain embodiments, the previously described polymerizable monomer and optional polymer is present in the oil-in-water Pickering emulsions of the present invention in an amount ranging from 5 to 50 percent, such as 5 to 40 percent by weight, based on the total weight of the emulsion.

In addition to the polymerizable monomer and optional polymer described above, the Pickering emulsions of the present invention also comprise a solid particle stabilizer. As used herein, the term “stabilizer” refers to a material that acts to stabilize the droplets of the dispersed phase in the continuous phase in the Pickering emulsions and aqueous dispersions of the present invention. In the present invention, the stabilizing solid particles are disposed at the interface of the dispersed phase and the continuous phase in the form of a substantially continuous layer of stabilizing solid particles. With reference to the Pickering emulsions of the present invention, the term “substantially continuous layer of stabilizing solid particles” means that the solid particles form a coating on the surface of the monomer droplets that is sufficiently continuous enough to prevent coalescence of the droplets within the aqueous medium.

Any solid particles that act as a stabilizer may be used in the present invention. Suitable particles include, for example, inorganic materials, such as water insoluble metal salts or metal hydroxides or metal oxides or mixed metal oxides or clays. Specific non-limiting examples include bentonite, tin oxide, magnesium aluminum silicate, magnesium oxide, titanium oxide, and/or silica, such as is described in U.S. Pat. No. 4,833,060 at col. 4, lines 54-61, the cited portion of which being incorporated herein by reference, and alumina as described in United States Patent Application Publication 2005/0156340 at [0067], the cited portion of which being incorporated herein by reference.

In certain embodiments, the solid particle stabilizer comprises electrically conductive particles and/or thermally conductive particles. The use of such particles, as will be appreciated upon reading of the disclosure herein, can result in the production of a network of solid particles that is electrically and/or thermally conductive and, as a result, such a network could serve as a pathway to conduct or dissipate heat or electrical charge.

Examples of electrically conductive particles, which are suitable for use as a solid particle stabilizer in the present invention are: particles of certain metal oxides, such as tin oxide, antimony-doped tin oxide, fluorine-doped tin oxide, indium-doped tin oxide, phosphorous-doped tin oxide, zinc antimonite, indium-doped zinc oxide, ruthenium oxide, rhenium oxide, silver oxide, nickel oxide, copper oxide, and the like; particles of carbon black, graphite, copper, silver, gold, nickel, tantalum, chromium, zirconium, vanadium, niobium and the like; as well as non-conductive particles, such as titanium dioxide, surface coated with an electrically conductive material, such as a tin oxide; and including mixtures of any of the foregoing particles.

Examples of thermally conductive particles, which are suitable for use as a solid particle stabilizer in the present invention are particles comprising aluminum oxide, aluminum nitride, boron nitride, boron carbide, silicon carbide, silicon nitride, silicon oxide, magnesium oxide, magnesium nitride, titanium dioxide, zinc oxide, silver, gold, copper, carbon (including diamond) and metal coated materials, such as silver coated copper or silver coated aluminum, as well as mixtures of any of the foregoing particles.

In certain embodiments, the solid particles, such as silica and/or alumina particles, are introduced into the Pickering emulsion in the form of colloidal dispersion, wherein finely divided solid particles are dispersed within a continuous medium in a manner that prevents them from being filtered easily or settled rapidly. Such dispersions are commercially available and an example is SNOWTEX-O, which is an aqueous colloidal silica sol having a pH of 2-4 and believed to contain 20 to 21 percent by weight nanosized (10-20 nanometers) silica particles dispersed in water.

In certain embodiments, the solid particle stabilizer present in the present invention comprises ultrafine particles. As used herein, the term “ultrafine particles” refers to particles that have a B.E.T. specific surface area of at least 10 square meters per gram, such as 30 to 500 square meters per gram, or, in some cases, 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the previously described ultrafine particles have a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:

Diameter (nanometers)=6000/[BET(m²/g)*ρ(grams/cm³)]

In certain embodiments, the solid particle stabilizer comprises particles having an average primary particle size of no more than 100 nanometers, such as no more than 50 nanometers, or, in certain embodiments, no more than 20 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification. The primary particle size of a particle refers to the smallest diameter sphere that will completely enclose the particle. As used herein, the term “primary particle size” refers to the size of an individual particle as opposed to an agglomeration of two or more individual particles.

The shape (or morphology) of the solid particle stabilizer can vary. For example, generally spherical morphologies can be used, as well as particles that are cubic, platy, or acicular (elongated or fibrous).

In certain embodiments, the solid particle stabilizer is present in the oil-in-water Pickering emulsions of the present invention in an amount ranging from 0.2 to 20 percent, such as 1 to 16 percent by weight, based on the total weight of the emulsion.

Moreover, in addition to the previously described polymerizable monomer, optional polymer and particulate stabilizer, the Pickering emulsions of the present invention also comprise a water insoluble promoter. As used herein, the term “water insoluble” means that the promoter is essentially not compatible with and/or is not capable of dissolving in water, i.e., upon mixing a sample of the promoter with an organic component and water, a majority of the promoter is in the organic phase and a separate aqueous phase is observed. See Hawley's Condensed Chemical Dictionary, (12th Ed. 1993) at page 618. For example, in certain embodiments, the water insoluble promoter utilized in the present invention has a solubility in distilled water of less than 6 grams promoter per 100 grams water at 25° C., as determined by placing 6 grams of water and 0.36 grams of promoter in a test tube at 25° C. and shaking the test tube. If, within one hour after shaking is complete, the promoter separates out from the water in the test tube, then the promoter has a solubility of less than 6 grams promoter per 100 grams water at 25° C. As used herein, the term “promoter” refers to a substance that drives the solid particle stabilizer to the interface between the dispersed phase and the continuous phase in the oil-in-water Pickering emulsions and aqueous dispersions of the present invention.

It was a surprising discovery that the use of a water insoluble, hydrophobic, promoter effectively drives the solid particle stabilizer to the interface between the dispersed phase and the continuous phase in the oil-in-water Pickering emulsions and aqueous dispersions of the present invention. In particular, it was surprising to discover that the use of a material having insufficient hydrogen bonds to produce water solubility was still able to adsorb to the surface of the solid particle stabilizer to an extent sufficient to render the particles at least partially organophilic. In the Pickering emulsions of the present invention, since the water insoluble promoter is introduced to the emulsion in a different phase from the solid particle stabilizer, adsorption to the particles does not occur until the emulsion is homogenized.

The water insoluble promoter utilized in the present invention has groups that have an affinity for groups that may be present the surface of the solid particle stabilizer, thus causing the promoter to adsorb to the solid particle stabilizer. For example, as will be appreciated, silica and alumina particles often include surface hydroxyl groups. As a result, when the solid particle stabilizer comprises such particles in the present invention, it is desired that the water insoluble promoter comprises groups that have an affinity for such hydroxyl groups, such as, for example, ether groups, carbamate groups, and ester groups.

Moreover, in certain embodiments, the water insoluble promoter is adapted to be chemically bound into the polymeric droplets of the dispersed phase formed from, for example, the reaction of the polymerizable monomers described earlier, i.e., the hydrophobic promoter is reactive in the sense that it contains functional groups, such as ethylenically unsaturated groups, which are capable of coreacting, for example, with functional groups present on the polymerizable monomer droplets.

In certain embodiments, the water insoluble promoter present in the oil-in-water Pickering emulsions of the present invention comprises a polymeric film-forming material, such as an aminoplast, a polyester, a polyether, a polyurethane, or a mixture thereof. In certain embodiments, the water insoluble promoter comprises a polymer that has a number average molecular weight greater than 500, such as greater than 800, or, in some cases, from 800 to 10,000, such as 800 to 3000. In certain embodiments, the glass transition temperature of the polymeric water insoluble promoter ranges from −50° C. to +50° C., such as −25° C. to +25° C.

Suitable aminoplasts, which can be used as the water insoluble promoter in the present invention, include, for example, highly alkylated melamine formaldehyde condensates, such as the Cymel® 1100 series condensates available from Cytec Industries, Inc. of West Patterson, N.J.

Suitable water insoluble polyester resins which can be used as the water insoluble promoter in the oil-in-water Pickering emulsions and aqueous dispersions of the present invention include those derived from polyfunctional acids and polyhydric alcohols. In certain embodiments, the polyester resin contains essentially no oil or fatty acid modification. That is, while alkyd resins are in the broadest sense polyester type resins, they are oil-modified and thus not generally referred to as polyester resins. Commonly used polyhydric alcohols include 1,4-butanediol, 1,6-hexanediol, neopentyl glycol, ethylene glycol, propylene glycol, diethylene glycol, dipropylene glycol, butylene glycol, glycerol, trimethylolpropane, pentaerythritol and sorbitol. A saturated acid often will be included in the reaction to provide desirable properties. Examples of saturated acids include phthalic acid, isophthalic acid, adipic acid, azelaic acid, sebacic acid and the anhydrides thereof. Useful saturated polyesters are derived from saturated or aromatic polyfunctional acids, such as dicarboxylic acids, and mixtures of polyhydric alcohols having an average hydroxyl functionality of at least 2. Mixtures of rigid and flexible diacids are sometimes desired. Monocarboxylic acids, such as benzoic acid, can be used in addition to polycarboxylic acids. Dicarboxylic acids or anhydrides such as isophthalic acid, phthalic anhydride, adipic acid, and maleic anhydride are often used. Other useful components of polyesters can include hydroxy acids and lactones such as ricinoleic acids, 12-hydroxystearic acid, caprolactone, butyrolactone and dimethylolpropionic acid.

Suitable water insoluble polyurethane resins which can be used as a promoter in the present invention can be prepared by reacting a polyol with a polyisocyanate. The reaction can be performed with a minor amount of organic polyisocyanate (OH/NCO equivalent ratio greater than 1:1) so that terminal hydroxyl groups are present or alternatively the OH/NCO equivalent ratio can be less than 1:1 thus producing terminal isocyanate groups.

The organic polyisocyanate can be an aliphatic polyisocyanate, including a cycloaliphatic polyisocyanate, or an aromatic polyisocyanate. Useful aliphatic polyisocyanates include aliphatic diisocyanates such as ethylene diisocyanate, 1,2-diisocyanatopropane, 1,3-diisocyanatopropane, 1,6-diisocyanatohexane, 1,4-butylene diisocyanate, lysine diisocyanate, 1,4-methylene bis (cyclohexyl isocyanate) and isophorone diisocyanate. Useful aromatic diisocyanates and araliphatic diisocyanates include the various isomers of toluene diisocyanate, meta-xylylene diisocyanate and para-xylylene diisocyanate, also 4-chloro-1,3-phenylene diisocyanate, 1,5-tetrahydro-naphthalene diisocyanate, 4,4′-dibenzyl diisocyanate and 1,2,4-benzene triisocyanate can be used. In addition, the various isomers of alpha, alpha, alpha′, alpha′-tetramethyl xylylene diisocyanate can be used. Also useful as the polyisocyanate are isocyanurates such as DESMODUR 3300 and biurets of isocyanates such as DESMODUR N100, both of which are commercially available from Bayer, Inc. of Pittsburgh, Pa.

The polyol can be polymeric such as polyester polyols, polyether polyols, polyurethane polyols, etc. or it can be a simple diol or triol such as ethylene glycol, propylene glycol, butylene glycol, glycerol, trimethylolpropane or hexanetriol. Mixtures can also be utilized.

Examples of useful water insoluble polyethers that can be used as a promoter in the present invention are polyalkylene ether polyols, such as those that

include repeat units having the following structural formulae:

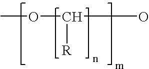

or

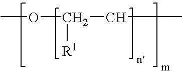

where the substituent R is hydrogen or lower alkyl containing from 1 to 5 carbon atoms including mixed substituents; R¹ is a lower alkyl containing from 1 to 5 carbon atoms including mixed substituents; n is an integer ranging from 2 to 6, except that when R is hydrogen then n is at least 4; n′ is an integer ranging from 1 to 6; and m is an integer ranging from 10 to 100 or even higher. Non-limiting examples of useful polyalkylene ether materials include poly(oxytetramethylene) glycols, poly(oxy-1,2-propylene) glycols and poly(oxy-1,2-butylene) glycols.

Also useful are polyether polyols formed from oxyalkylation of various polyols, for example, glycols such as ethylene glycol, 1,6-hexanediol, Bisphenol A and the like, or other higher polyols, such as trimethylolpropane, pentaerythritol and the like. Polyols of higher functionality which can be utilized as indicated can be made, for example, by oxyalkylation of compounds such as sorbitol or sucrose. One commonly utilized oxyalkylation method is by reacting a polyol with an alkylene oxide, for example, propylene oxide, in the presence of an acidic or basic catalyst.

With polyether polyols, it is often desirable that the carbon to oxygen weight ratio be high for better hydrophobic properties. Thus, it is often desirable that the carbon to oxygen ratio be greater than 3/1, such as greater than 4/1.

As indicated earlier, the water insoluble promoter, such as any of the previously described aminoplasts, polyesters, polyethers, and/or polyurethanes can be adapted so that a portion thereof can be reacted with an ethylenically unsaturated monomer. That is, the promoter can be chemically bound to an ethylenically unsaturated component that is capable of undergoing free radical copolymerization with acrylic and/or vinyl monomers. One means of making the promoter graftable is by including in its composition an ethylenically unsaturated acid or anhydride such as crotonic acid, maleic anhydride, or methacrylic anhydride. For example, an isocyanate-functional 1:1 adduct of hydroxyethyl methacrylate and isophorone diisocyanate can be reacted with hydroxyl functionality in the polyurethane to make it copolymerizable with acrylic monomers.

Such materials are also commercially available. Examples include polyether acrylates, such as SR306, SR604, CD513, CD611, commercially available from Sartomer Company, Inc. of Exton, Pa.; Miramer M1602 commercially available from Miwon Commercial Co., Ltd.; Photomer 8061, Photomer 8127, and Bisomer PPA6, commercially available from Cognis Corp., as well as poly(THF) acrylates and polyester acrylates, such as Tone M-100, commercially available from Dow Chemical Co.

The water insoluble promoter can optionally contain other components included to modify certain of its properties. For example, it can contain urea or amide functionality. Suitable urea functional water insoluble polymers include acrylic polymers having pendant urea groups, which can be prepared by copolymerizing acrylic monomers with urea functional vinyl monomers such as urea functional alkyl esters of acrylic acid or methacrylic acid. An example includes the condensation product of acrylic acid or methacrylic acid with a hydroxyalkyl ethylene urea such as hydroxyethyl ethylene urea. Other urea functional monomers include, for example, the reaction product of hydroxyethyl methacrylate, isophorone diisocyanate and hydroxyethyl ethylene urea. Mixed pendant carbamate and urea groups can also be used.

Other useful urea functional water insoluble polymers include polyesters having pendant urea groups, which can be prepared by reacting a hydroxyl functional urea, such as hydroxyalkyl ethylene urea, with the polyacids and polyols used to form the polyester. A polyester oligomer can be prepared by reacting a polyacid with a hydroxyl functional urea. Also, isocyanate-terminated polyurethane or polyester prepolymers can be reacted with primary amines, aminoalkyl ethylene urea or hydroxyalkyl ethylene urea to yield materials with pendant urea groups. Preparation of these polymers is described in U.S. Pat. No. 3,563,957.

Useful polyamides include acrylic polymers having pendant amide groups. Pendant amide groups can be incorporated into an acrylic polymer by co-polymerizing the acrylic monomers with amide functional monomers such as (meth)acrylamide and N-alkyl (meth)acrylamides including N-t-butyl (meth)acrylamide, N-t-octyl (meth)acrylamide, N-isopropyl (meth) acrylamide, and the like. Alternatively, amide functionality may be incorporated into a polymer by post-reaction, for example, by first preparing an acid functional polymer, such as an acid functional polyester or polyurethane, and then reacting the acid functional polymer with ammonia or an amine using conventional amidation reaction conditions, or, alternatively, by preparing a polymer having pendant ester groups (such as by using alkyl (meth) acrylates) and reacting the polymer with ammonia or a primary amine.

Pendant amide functional groups can be incorporated into a polyester polymer by preparing a carboxylic acid functional polyester and reacting with ammonia or amine using conventional amidation conditions.

In certain embodiments, the water insoluble promoter is present in the oil-in-water Pickering emulsions of the present invention in an amount ranging from 0.1 to 45 percent, such as 0.2 to 12 percent by weight, based on the total weight of the emulsion.

As previously indicated, the Pickering emulsions and aqueous dispersions of the present invention also comprise a continuous phase comprising an aqueous medium. The aqueous medium is often exclusively water. However, in some cases, it can be desirable to also include a minor amount of inert organic solvent in the continuous phase. In certain embodiments, the amount of organic solvent present is less than 20 weight percent, such as less than 10 weight percent, or, in some cases, less than 5 weight percent, or, in yet other cases, less than 2 weight percent based on total weight of the emulsion. Examples of suitable organic solvents which can be incorporated for this purpose include, but are not limited to, propylene glycol monobutyl ether, ethylene glycol monohexyl ether, ethylene glycol monobutyl ether, n-butanol, and benzyl alcohol, as well as mixtures thereof.

The Pickering emulsions of the present invention may include other materials, such as catalysts and/or initiators. For example, any catalyst or initiator that is soluble in the particular monomer or monomers polymerized within the droplets may be utilized in the present invention. Typical initiators for polymerization are the peroxide and azo initiators, such as 2,2′ azobis (2,4-dimethyl valeronitrile), lauroyl peroxide, benzoyl peroxide, and the like. Also suitable are water soluble initiators, such as ammonium peroxydisulfate, potassium peroxydisulfate and hydrogen peroxide.

In certain embodiments the Pickering emulsions of the present invention are substantially, or, in some cases, completely free of pH control agents, such as sodium bisulfate, citric acid, sodium carbonate, sodium bicarbonate, and quaternary ammonium compounds. As used herein, the term “substantially free” when used with reference to the absence of pH control agents in the Pickering emulsions of the present invention, means that such a material is not present in the emulsion in any amount sufficient to affect the properties of the emulsion. Also, as used herein, the term “completely free” when used with reference to the absence of pH control agents in the Pickering emulsions of the present invention, means that such a material is not present in the emulsion at all.

As previously indicated, the present invention is also directed to aqueous dispersions comprising polymeric particles, i.e., droplets, coated with a substantially continuous layer of stabilizing solid particles having a water insoluble promoter adsorbed thereto, wherein the polymeric particles are dispersed in an aqueous medium. Such aqueous dispersions of the present invention can be prepared, for example, from the previously described Pickering emulsions by, for example, a so-called “suspension polymerization” technique wherein the polymerizable monomers, optional polymers, and water insoluble promoter described above are added to an aqueous medium containing a particulate suspension of solid particle stabilizer. The mixture is agitated under shearing forces to reduce the size of the droplets. During this time an equilibrium is reached and the size of the droplets is stabilized by the action of the solid particle stabilizer in coating the surface of the droplets. Polymerization is completed to form an aqueous suspension of polymer particles coated with a substantially continuous layer of stabilizing solid particles having a water insoluble promoter adhered thereto. As used herein, the term “substantially continuous layer of stabilizing solid particles” means that the solid particles form a coating on the surface of the polymer particles that is sufficiently continuous enough to prevent coalescence of the polymer particles within the aqueous medium.

In certain embodiments of the present invention, the average diameter of the polymeric particles coated with a substantially continuous layer of stabilizing solid particles having a water insoluble promoter adhered thereto is from 0.05 μm to 100 μm, such as 0.1 μm to 60 μm.

The present invention is also directed to coating compositions comprising the aqueous dispersions described herein. Such coating compositions can be thermoplastic compositions or thermosetting (i.e.) curable compositions. As used herein, by “thermosetting material” or “thermosetting composition” is meant one which “sets” irreversibly upon curing or crosslinking, wherein the polymer chains of the polymeric components are joined together by covalent bonds. This property is usually associated with a cross-linking reaction of the composition constituents often induced, for example, by heat or radiation. Hawley, Gessner G., The Condensed Chemical Dictionary, Ninth Edition., page 856; Surface Coatings, vol. 2, Oil and Colour Chemists' Association, Australia, TAFE Educational Books (1974). Once cured or crosslinked, a thermosetting material or composition will not melt upon the application of heat and is insoluble in solvents. By contrast, a “thermoplastic material” or “thermoplastic composition” comprises polymeric components which are not joined by covalent bonds and thereby can undergo liquid flow upon heating and are soluble in solvents. Saunders, K.J., Organic Polymer Chemistry, pp. 41-42, Chapman and Hall, London (1973).

The aqueous dispersions of polymeric particles described herein can represent the primary film-forming component of such coating compositions, or, alternatively the aqueous dispersion can represent only one of the components in the coating composition. For example, in addition to the aqueous dispersion of the present invention, such coating compositions also can include a resinous binder system comprising one or more film-forming polymers which may or may not include reactive functional groups, and/or, if appropriate, a crosslinking agent having functional groups reactive with those of the film-forming polymer.

The coating compositions of the present invention can be used in a variety of applications, such as, for example, in automotive coatings, automotive refinish coatings, industrial coatings, architectural coatings, coil coatings, and aerospace coatings.

It should be understood that the amount of the aqueous dispersion of polymeric particles present in the coating compositions can vary widely depending upon a variety of factors. For example, the aqueous dispersion of polymeric particles can be present in the coating composition in an amount as low as 0.05 weight percent and as high as 100 weight percent.

In addition to the aqueous dispersion of polymeric particles, the coating composition of the present invention can comprise one or more additional film-forming polymers. Film-forming polymers suitable for this use in the coating composition can include, for example, any of those polymers discussed above with respect to the aqueous dispersion of polymeric particles.

The coating compositions of the present invention can further comprise one or more colorants. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which are incorporated herein by reference.

Example special effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating composition of the present invention also can comprise optional ingredients such as those well known in the art of formulating surface coatings. Such optional ingredients can comprise, for example, surface active agents, flow control agents, thixotropic agents, fillers, anti-gassing agents, organic co-solvents, catalysts, and other customary auxiliaries. Nonlimiting examples of these materials and suitable amounts are described in U.S. Pat. Nos. 4,220,679; 4,403,003; 4,147,769; and 5,071,904.

The coating composition of the present invention may be used to form a single coating, for example, a monocoat, a clear top coating or a base coat in a two-layered system or both; or as one or more layers of a multi-layered system including a clear top coating composition, a colorant layer and/or a base coating composition, and/or a primer layer, including, for example, a primer-surfacer layer.

The coating compositions of the present invention can be applied to any suitable substrate by any of the conventional coating techniques known to those skilled in the art. Suitable substrates include human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates also include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable substrates also include metallic substrates, such as, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable. Such weldable coating compositions are disclosed in U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

Polymeric substrates are also suitable and include, for example, polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine/, dicyanodiamide/and/or urea/formaldehyde resins.

The coating compositions of the present invention are also suitable for application to compressible substrates, such as foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe midsoles. Different types of EVA foam can have different types of surface porosity. Molded EVA can comprise a dense surface or “skin”, whereas flat sheets or slabs can exhibit a porous surface.

After application of the coating compositions of the present invention to the substrate, the composition is allowed to coalesce. Typically, the film thickness will be 0.01 to 20 mils (about 0.25 to 508 microns), such as 0.01 to 5 mils (0.25 to 127 microns), or, in some cases, 0.1 to 2 mils (2.54 to 50.8 microns) in thickness. The film is formed on the surface of the substrate by driving diluent, i.e., organic solvent and/or water, out of the film by heating or by an air drying period. In some cases, the heating will only be for a short period of time, sufficient to ensure that any subsequently applied coatings can be applied to the film without dissolving the composition. Suitable drying conditions will depend on the particular composition, but, in general, a drying time of from about 1 to 5 minutes at a temperature of about 68° F. to 250° F. (20° C. to 121° C.) will be adequate. More than one coat of the coating composition may be applied to develop the optimum appearance. Between coats, the previously applied coat may be flashed, that is, exposed to ambient conditions for about 1 to 20 minutes.

The inventors have discovered that the aqueous dispersions of the present invention, when employed in a coating composition that is deposited upon a substrate, can form a multiphase coating comprising: (a) a first phase comprising a plurality of film-forming polymer domains; and (b) a second phase comprising a network of solid particles. In these coatings of the present invention, the plurality of film-forming polymer domains are separated from each other by the network of solid particles. As a result, the present invention is also directed to such coatings. In certain embodiments of these coatings of the present invention, the polymer domains comprise the water insoluble promoter described herein.

In addition, it has been discovered that, if desired, the polymer domains in such a multiphase coating can be removed to provide a network of solid particles deposited on a substrate in the absence of a polymer. As a result, the present invention is also directed to methods for making a film comprising a network of solid particles. These methods comprise (1) making a Pickering emulsion comprising: (a) a dispersed phase comprising droplets of a polymerizable monomer coated with a substantially continuous layer of stabilizing solid particles having a water insoluble promoter adsorbed thereto; and (b) a continuous phase comprising an aqueous medium, wherein the substantially continuous layer of stabilizing solid particles is disposed at the interface of the dispersed phase and the continuous phase; (2) polymerizing the polymerizable monomer to form an aqueous dispersion comprising polymeric particles coated with a substantially continuous layer of stabilizing solid particles having a water insoluble promoter adsorbed thereto, wherein the polymeric particles are dispersed in an aqueous medium; (3) depositing the aqueous dispersion on a substrate; (4) drying the aqueous dispersion to form a multiphase coating comprising: (a) a first phase comprising a plurality of film-forming polymer domains; and (b) a second phase comprising a network of solid particles, wherein the plurality of film-forming polymer domains are separated from each other by the network of solid particles; and (5) removing the polymeric domains. In these methods of the present invention, the aqueous medium and the polymeric domains can be removed by any suitable technique, such as evaporation, oven-drying, or freeze-drying for removal of the aqueous medium and high temperature sintering or solvent dissolution for the polymeric domains.

Illustrating the invention are the following examples that are not to be considered as limiting the invention to their details. All parts and percentages in the examples, as well as throughout the specification, are by weight unless otherwise indicated.

### EXAMPLE 1

A mixture of 107.57 grams of Snowtex-O and 46.57 grams deionized water were placed in a beaker. A monomer mixture was prepared in a separate vessel by mixing 21.50 grams methyl methacrylate, 15.05 grams butyl acrylate, 6.02 grams butyl methacrylate, 4.30 grams 2-hydroxyethylmethacrylate, 0.43 grams acrylic acid and 31.45 grams Cymel 1156 (a butylated melamine formaldehyde resin commercially available from Cytec Industries). The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. Following this, a mixture of 0.22 grams isoascorbic acid and 1.2 milligrams ferrous ammonium sulfate in 4.22 grams deionized water was added. After a 10 minute hold, the nitrogen sparge was switched to a nitrogen blanket and the dropwise addition of an initiator solution consisting of 0.45 grams of t-butylhydroperoxide (70% solution in water) in 4.91 grams deionized water was started. The initiator was fed into the reaction over a 10 minute period. The reaction mixture was then warmed to 40° C. with a peak exotherm temperature of 51° C. and held for 90 minutes. The resultant dispersion was filtered through a 124 mesh screen and the pH adjusted from 3.3 to 7 using dimethylethanolamine to give a 40% solids dispersion with a number average particle size of 0.42 micron.

### EXAMPLE 2

A mixture of 71.54 grams of Snowtex-O and 254.39 grams of deionized water were placed in a beaker. A monomer mixture was prepared in a separate vessel by mixing 48.00 grams methyl methacrylate, 68.57 grams butyl acrylate, 13.71 grams ethylhexyl acrylate, 5.71 grams 2-hydroxyethylmethacrylate, 3.43 grams acrylic acid, 29.71 grams Dowanol PM, 89.14 grams of a polyester resin (30.47% 1,4-cyclohexanedicarboxylic acid, 2.11% maleic anhydride, 12.59% isophthalic acid, 4.04% ethylene glycol, 20.79% 1,3-butylene glycol, 30% xylene), and 0.82 grams of Luperox A75, which is an organic peroxide commercially available from Elf Atochem North America, Philadelphia, Pa.). The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. After 30 minutes, the reaction was warmed to 60° C. and held for 4 hours. The dispersion obtained was 34.2% solids with a number average particle size of 1.93 micron.

### EXAMPLE 3

A mixture of 21.91 grams of Snowtex-O and 55.11 grams deionized water were placed in a beaker. A monomer mixture was prepared in a separate vessel by mixing 21.93 grams methyl methacrylate, 15.35 grams butyl acrylate, 6.14 grams butyl methacrylate, 4.39 grams 2-hydroxyethylmethacrylate, 0.44 grams acrylic acid and 8.58 grams of a polyurethane resin (prepared from MDI, propylene glycol, ethylene glycol monobutyl ether and methyl isobutyl ketone). The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. Following this, a mixture of 0.21 grams of isoascorbic acid and 1.1 milligrams of ferrous ammonium sulfate in 4.28 grams of deionized water was added. After a 10 minute hold, the nitrogen sparge was switched to a nitrogen blanket and the dropwise addition of an initiator solution consisting of 0.46 grams of t-butylhydroperoxide (70% solution in water) in 4.89 grams of deionized water was started. The initiator was fed into the reaction over a 10 minute period. The reaction mixture was then warmed to 40° C. with a peak exotherm temperature of 62° C. and held for 90 minutes. The resultant dispersion was filtered through a 124 mesh screen and the pH adjusted from 3.3 to 7 using dimethylethanolamine to give a 38.3% solids dispersion with a number average particle size of 1.78 micron.

### EXAMPLE 4

A mixture of 235.00 grams of Snowtex-O and 162.75 grams of deionized water were placed in a beaker. A monomer mixture was prepared in a separate vessel by mixing 45.12 grams methyl methacrylate, 49.84 grams butyl methacrylate, 53.20 grams 2-ethylhexyl acrylate, 10.51 grams cyclohexyl methacrylate, 16.30 grams 2-hydroxyethylmethacrylate, 3.59 grams methacrylic acid and 9.40 g Bisomer PPA6 (a poly(propylene glycol) acrylate commercially available from Cognis). The monomer mixture was then added with stirring at room temperature to the aqueous phase. The mixture was stirred for 10 minutes and then treated with a Ross mixer for 10 minutes to form the emulsion. The emulsified material was then placed in a flask, sparged with nitrogen, and warmed to 30° C. Following this, a mixture of 0.94 grams of isoascorbic acid and 3.8 milligrams of ferrous ammonium sulfate in 18.04 grams of deionized water was added. After a 10 minute hold, the nitrogen sparge was switched to a nitrogen blanket and the dropwise addition of an initiator solution consisting of 1.95 grams of t-butylhydroperoxide (70% solution in water) in 21.05 grams of deionized water was started. The initiator was fed into the reaction over a 10 minute period. The reaction mixture was then warmed to 40° C. and held for 90 minutes. The resultant dispersion was filtered through a 124 mesh screen and the pH adjusted to 8.8 using dimethylethanolamine to give a 36.7% solids dispersion with a number average particle size of 1.38 micron.

### EXAMPLE 5

A mixture of 405.00 grams of Snowtex-O and 397.83 grams of deionized water were placed in a beaker. A monomer mixture was prepared in a separate vessel by mixing 105.23 grams methyl methacrylate, 44.90 grams butyl acrylate, 9.32 grams 2-hydroxyethylmethacrylate, 3.22 grams methacrylic acid and 6.78 grams SR306 (a poly(propylene glycol) diacrylate commercially available from Sartomer). The monomer mixture was then added with stirring at room temperature to the aqueous phase. The mixture was stirred for 10 minutes and then treated with a Ross mixer for 10 minutes to form the emulsion. The emulsified material was then placed in a flask, sparged with nitrogen, and warmed to 30° C. Following this, a mixture of 0.85 grams of isoascorbic acid and 3.4 milligrams of ferrous ammonium sulfate in 16.27 grams of deionized water was added. After a 10 minute hold, the nitrogen sparge was switched to a nitrogen blanket and the dropwise addition of an initiator solution consisting of 1.76 grams of t-butylhydroperoxide (70% solution in water) in 18.98 grams of deionized water was started. The initiator was fed into the reaction over a 10 minute period. The reaction mixture was then warmed to 40° C. and held for 90 minutes. The resultant dispersion was filtered through a 124 mesh screen and the pH adjusted to 6.65 using dimethylethanolamine to give a 24.2% solids dispersion with a number average particle size of 0.24 micron.

### EXAMPLE 6

A mixture of 120.00 g of Snowtex-O and 57.11 grams of deionized water were placed in a beaker. A monomer mixture was prepared in a separate vessel by mixing 22.08 grams methyl methacrylate, 21.12 grams butyl acrylate, 4.80 grams 2-hydroxyethylmethacrylate, 0.48 grams acrylic acid and 2.40 grams Tone M-100 (a polyester acrylate commercially available from Dow Chemical Co.). The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. Following this, a mixture of 0.25 grams of isoascorbic acid and 1.0 milligrams ferrous ammonium sulfate in 4.88 grams of deionized water was added. After a 10 minute hold, the nitrogen sparge was switched to a nitrogen blanket and the dropwise addition of an initiator solution consisting of 0.53 grams of t-butylhydroperoxide (70% solution in water) in 5.70 grams of deionized water was started. The initiator was fed into the reaction over a 10 minute period. The reaction mixture was then warmed to 40° C. with a peak exotherm temperature of 51° C. and held for 90 minutes. The resultant dispersion was filtered through a 124 mesh screen and the pH adjusted to 6.1 using dimethylethanolamine to give a 29.3% solids dispersion with a number average particle size of 0.33 micron.

### COMPARATIVE EXAMPLE 1

A mixture of 120.00 grams of Snowtex-O and 63.24 grams of deionized water were placed in a beaker. A monomer mixture was prepared in a separate vessel by mixing 13.92 grams methyl methacrylate, 19.68 grams butyl acrylate, 6.00 grams butyl methacrylate, 4.80 grams 2-hydroxyethylmethacrylate, 1.20 grams acrylic acid and 2.40 grams of a 550 molecular weight polyethylene glycol methacrylate. The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. Following this, a mixture of 0.24 grams of isoascorbic acid and 1.0 milligrams of ferrous ammonium sulfate in 4.61 grams of deionized water was added. After a 10 minute hold, the nitrogen sparge was switched to a nitrogen blanket and the dropwise addition of an initiator solution consisting of 0.50 grams of t-butylhydroperoxide (70% solution in water) in 5.38 grams of deionized water was started. The initiator was fed into the reaction over a 10 minute period. The reaction mixture was then warmed to 40° C. with a peak exotherm temperature of 49° C. Approximately 15 minutes after the exotherm the reaction mixture began to thicken significantly to a point where it became non-pourable.

### COMPARATIVE EXAMPLE 2

A mixture of 90.26 grams of Snowtex-O and 47.57 grams of deionized water were placed in a beaker. The monomer mixture was prepared in a separate vessel by mixing 18.05 grams methyl methacrylate, 12.64 grams butyl acrylate, 5.05 grams butyl methacrylate, 2.89 grams 2-hydroxyethylmethacrylate, and 1.08 grams of 4-vinylpyridine. The monomer mixture was then added with stirring at room temperature to the aqueous phase. The mixture was stirred for 10 minutes and then treated with an ultrasonic probe for 10 minutes to form the emulsion. The emulsified material was then placed in a flask, sparged with nitrogen, and warmed to 30° C. Following this, a mixture of 0.18 grams of isoascorbic acid and 1.0 milligrams of ferrous ammonium sulfate in 3.47 grams of deionized water was added. After a 10 minute hold, the nitrogen sparge was switched to a nitrogen blanket and the dropwise addition of an initiator solution consisting of 0.37 grams of t-butylhydroperoxide (70% solution in water) in 4.04 grams of deionized water was started. The initiator was fed into the reaction over a 10 minute period. The reaction mixture was then warmed to 40° C. with a peak exotherm temperature of 68° C. The reaction mixture became increasingly thick during the hold and eventually somewhat clumpy.

### EXAMPLE 7

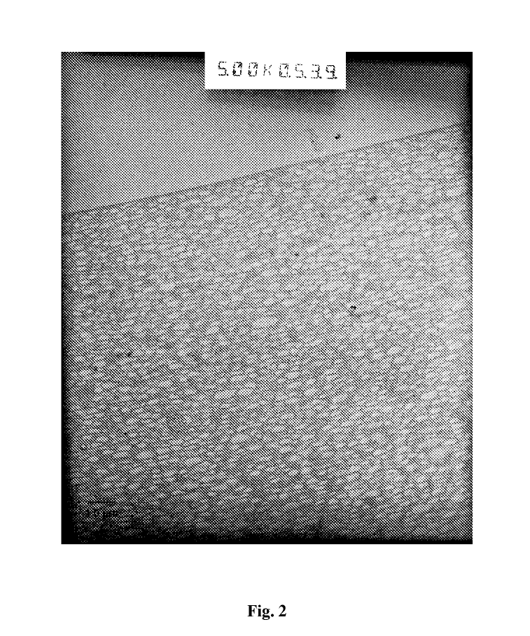

A film was prepared with the dispersion produced in Example 1 by performing a drawdown on a pretreated aluminum panel that had been cleaned with isopropanol and drying for 10 minutes at room temperature and 30 minutes at 170° C. FIG. 2 is a TEM image (5,000× magnification) of a cross-section of the dried film so produced.

### EXAMPLE 8

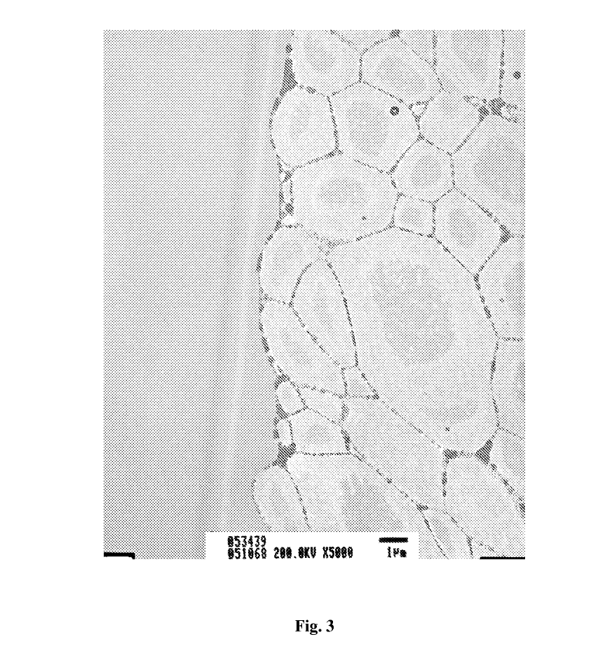

A film was prepared with the dispersion produced in Example 2 by performing a drawdown on a pretreated aluminum panel that had been cleaned with isopropanol and drying for 5 minutes at room temperature and 15 minutes at 110° C. FIG. 3 is a TEM image (5,000× magnification) of a cross-section of the dried film so produced.

### EXAMPLE 9

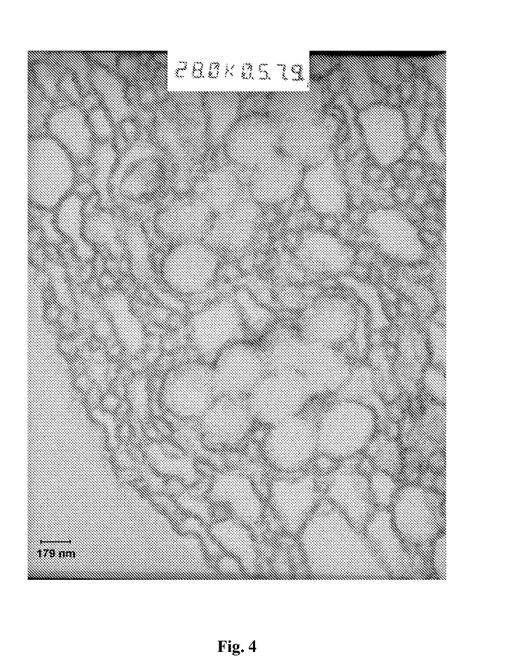

Two dispersions that had each been prepared separately using similar procedures described in the Examples above and with the following attributes were mixed together. The resultant mixture contained crosslinked (emulsion A) and non-crosslinked (emulsion B) particles and was used to form a film on a pretreated aluminum panel that had been cleaned with isopropanol by performing a drawdown. The film was dried at room temperature for 10 minutes and then at 170° C. for 30 minutes. FIG. 4 is a TEM image (28,000× magnification) of a cross-section of the dried film so produced.

Emulsion A: Contained 2.9 percent by weight 20 nanometers silica particles on solid weight, 8.7 percent by weight Cymel 1156 on solid weight and 88.4 percent by weight on solid weight a polymer with the following composition: 79.3 percent methyl methacrylate, 19.6 percent ethylene glycol dimethacrylate, 6 percent 2-hydroxyethylmethacrylate, and 0.6 percent acrylic acid. The number average particle size of this emulsion was 1.97 micron.

Emulsion B: Contained 22.6 percent by weight 20 nanometer silica particles on solid weight, 31.6 percent by weight Cymel 1156 on solid weight and 45.8 percent by weight on solid weight a polymer with the following composition: 50 percent methyl methacrylate, 35 percent butyl acrylate, 14 percent butyl methacrylate, 10 percent 2-hydroxyethylmethacrylate, and 1 percent acrylic acid. The number average particle size of this emulsion is 0.42 micron.

### COMPARATIVE EXAMPLE 3

A film was prepared from an emulsion prepared using benzyltriethylammonium chloride as promoter at a level of 0.5 percent on total emulsion weight and as the continuous phase a pH 4 buffer prepared in deionized water with potassium hydrogen phthalate and hydrochloric acid to prevent emulsion flocculation or thickening. The polymer contained in this emulsion had a composition consisting of 40 percent methyl methacrylate, 35 percent butyl acrylate, 14 percent butyl methacrylate, 10 percent 2-hydroxyethylmethacrylate, and 1 percent acrylic acid. A film was prepared from this emulsion by performing a drawdown on a pretreated aluminum panel that had been cleaned with isopropanol and drying for 5 minutes at room temperature and 15 minutes at 110° C. The resultant film easily crumbled.

### Solubility Testing

The solubility of various materials (see Table 1) in water was tested according to the following procedure: Into a test tube was placed 6 grams of deionized water and 0.36 grams of the material to be tested. The tube was then shaken and allowed to settle to determine if the material would separate out from the water or not. The results are shown in Table 1.

TABLE 1

| Promoter | Solubility Result |
|---|---|
| Bisomer PPA6 | Insoluble - material separated from water |
| | within 1 hour after shaking was completed |
| SR306 | Insoluble - material separated from water |
| | within 1 hour after shaking was completed |
| Cymel 1156 | Insoluble - material separated from water |
| | within 1 hour after shaking was completed |
| Tone M-100 | Insoluble - material separated from water |
| | within 1 hour after shaking was completed |
| Benzyltriethylammonium | Soluble - material did not separate from water |
| chloride | within 1 hour after shaking was completed |
| mPEG 550 methacrylate | Soluble - material did not separate from water |
| | within 1 hour after shaking was completed |
| 4-Vinylpyridine | Soluble - material did not separate from water |
| | within 1 hour after shaking was completed |

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. An oil-in-water Pickering emulsion comprising:
(a) a dispersed phase comprising droplets of a polymerizable monomer coated with a substantially continuous layer of stabilizing solid particles having a water insoluble promoter adsorbed thereto; and
(b) a continuous phase comprising an aqueous medium,
wherein the substantially continuous layer of stabilizing solid particles is disposed at the interface between the dispersed phase and the continuous phase.

2. The emulsion of claim 1, wherein the emulsion is substantially free of surfactant.

3. The emulsion of claim 1, wherein the polymerizable monomer comprises a polymerizable ethylenically unsaturated monomer.

4. The emulsion of claim 1, wherein the stabilizing solid particles comprise inorganic particles.

5. The emulsion of claim 4, wherein the stabilizing solid inorganic particles comprise a metal oxide, a mixed metal oxide, or a mixture thereof.

6. The emulsion of claim 4, wherein the stabilizing solid inorganic particles comprise bentonite, tin oxide, alumina, magnesium aluminum silicate, magnesium oxide, titanium oxide, silica, or a mixture thereof.

7. The emulsion of claim 6, wherein the stabilizing solid inorganic particles comprise silica.

8. The emulsion of claim 1, wherein the stabilizing solid particles comprise electrically conductive particles and/or thermally conductive particles.

9. The emulsion of claim 1, wherein the stabilizing solid particles are in the form of a colloidal dispersion.

10. The emulsion of claim 1, wherein the stabilizing solid particles comprise ultrafine particles.

11. The emulsion of claim 1, wherein the water insoluble promoter has a solubility in distilled water of less than 6 grams promoter per 100 grams water at 25° C.

12. The emulsion of claim 1, wherein the water insoluble promoter comprises groups that have an affinity for hydroxyl groups.

13. The emulsion of claim 1, wherein the water insoluble promoter comprises functional groups capable of coreacting with the polymerizable monomer.

14. The emulsion of claim 1, wherein the water insoluble promoter comprises a film-forming polymer.

15. The emulsion of claim 14, wherein the water insoluble promoter comprises an aminoplast, a polyester, a polyether, a polyurethane, or a mixture thereof.

16. The emulsion of claim 15, wherein the water insoluble promoter comprises a polyether acrylate.

17. An aqueous dispersion comprising
(a) a dispersed phase comprising polymeric particles coated with a substantially continuous layer of stabilizing solid particles having a water insoluble promoter adsorbed thereto; and
(b) a continuous phase comprising an aqueous medium,
wherein the substantially continuous layer of stabilizing solid particles is disposed at the interface between the dispersed phase and the continuous phase.

18. The aqueous dispersion of claim 17, wherein the average diameter of the polymeric particles is from 0.05 μm to 100 μm.

19. The aqueous dispersion of claim 17, wherein the emulsion is substantially free of surfactant.

20. The aqueous dispersion of claim 17, wherein the stabilizing solid particles comprise inorganic particles.

21. The aqueous dispersion of claim 17, wherein the stabilizing solid inorganic particles comprise a metal oxide, a mixed metal oxide, or a mixture thereof.

22. The aqueous dispersion of claim 17, wherein the stabilizing solid inorganic particles comprise bentonite, alumina, tin oxide, magnesium aluminum silicate, magnesium oxide, titanium oxide, silica, or a mixture thereof.

23. The aqueous dispersion of claim 17, wherein the stabilizing solid particles comprise electrically conductive particles and/or thermally conductive particles.

24. The aqueous dispersion of claim 17, wherein the stabilizing solid particles comprise ultrafine particles.

25. The aqueous dispersion of claim 17, wherein the water insoluble promoter is coreacted with the polymerizable monomer.

26. The aqueous dispersion of claim 17, wherein the water insoluble promoter comprises an aminoplast, a polyester, a polyether, a polyurethane, or a mixture thereof.

27. A coating composition comprising the aqueous dispersion of claim 17.

28. A substrate at least partially coated with the coating composition of claim 27.

29. A multiphase coating comprising:
(a) a first phase comprising a plurality of film-forming polymer domains; and
(b) a second phase comprising a network of solid particles,
wherein the plurality of film-forming polymer domains are separated from each other by the network of solid particles.

30. A method for making a network of solid particles, comprising:
(1) making a Pickering emulsion comprising:
(a) a dispersed phase comprising droplets of a polymerizable monomer coated with a substantially continuous layer of stabilizing solid particles having a water insoluble promoter adsorbed thereto; and
(b) a continuous phase comprising an aqueous medium, wherein the substantially continuous layer of stabilizing solid particles is disposed at the interface between the dispersed phase and the continuous phase;
(2) polymerizing the polymerizable monomer to form an aqueous dispersion comprising polymeric particles coated with a substantially continuous layer of stabilizing solid particles having a water insoluble promoter adsorbed thereto, wherein the polymeric particles are dispersed in an aqueous medium;
(3) depositing the aqueous dispersion on a substrate;
(4) drying the aqueous dispersion to form a multiphase coating comprising:
(a) a first phase comprising a plurality of film-forming polymer domains; and
(b) a second phase comprising a network of solid particles, wherein the plurality of film-forming polymer domains are separated from each other by the network of solid particles; and
(5) removing the polymer domains.
